(19) United States
(12) Patent Application Publication
(10) Pub. No.: US 2014/0359499 A1
(43) Pub. Date: Dec. 4, 2014

(54) SYSTEMS AND METHODS FOR DYNAMIC USER INTERFACE GENERATION AND PRESENTATION

(71) Applicants: Frank Cho, Chicago, IL (US); Bryan Powell, Longmont, CO (US)

(72) Inventors: Frank Cho, Chicago, IL (US); Bryan Powell, Longmont, CO (US)

(21) Appl. No.: 14/267,647

(22) Filed: May 1, 2014

Related U.S. Application Data
(60) Provisional application No. 61/818,783, filed on May 2, 2013.

(51) Int. Cl. G06F 3/0481; G06F 17/27

(52) U.S. Cl. CPC G06F 3/0481; G06F 17/2785
USPC 715/765

(57) ABSTRACT

The present invention provides systems and methods for generating and delivering a dynamic user interface to computing systems and/or devices associated with the user. By using information based on context, location, and situational needs of the user, the present invention is able to predict, adapt, organize and visualize relevant information responsive to the user in a dynamic user interface. The present invention is able to incorporate data inputs from multiple devices as well as internet “cloud” based information and deliver a dynamic user interface across one or more devices to provide users a more exact situational awareness of themselves.

### CROSS-REFERENCE TO RELATED APPLICATION

The present application claims priority to U.S. provisional application Ser. No. 61818783 which was filed on May 2, 2013, entitled Systems and Methods for Dynamic User Interface Generation and Presentation, the disclosure of which is incorporated by reference herein in its entirety.

### BACKGROUND

Everyday, people interact with a multitude of computing devices and have unprecedented access to information for use in every aspect of daily activity. As the accessibility to computing devices has increased, so too has the number and variety of user interfaces. Interactive user interface displays have been integrated into many electronic devices. Typically, these displays provide a fixed visual layer to access underlying data.

### SUMMARY

Conventional implementations of user interfaces and traditional computing models do 20 not sufficiently provide relevant views of a user's data, nor provide adaptive views of a user's information tailored to context, location, and situational needs. Further, it is also realized that adaptive views are needed that can transition between the multitude of computing devices associated with a user as the user comes into contact with different computing devices.

Stated broadly, various aspects of the present disclosure describe systems and methods for generating and delivering a dynamic user interface to computing systems and/or devices associated with a user. According to some embodiments, the user interface can be configured to predict, adapt, organize, and visualize relevant information responsive to the user's context, location, and situational needs. In one embodiment, the dynamic user interface system executes semantic searching against information on a user to identify data relevant to the user's current context (e.g., location, position, accessible devices, visualizable devices, situational needs (e.g., going to work, getting out of bed, in vehicle, leaving house, etc.), and prior user behavior, among other examples). The system can be configured to generate a dynamic user interface for integrating the relevant data returned into a visual display of the data and data relationship structures. As opposed to conventional models of the user interface where the UI is simply a visual layer on top of data managed by an operating system, the dynamic user interface forms an integral part of the data relationship structures that change and adapt as the user's contextual information changes. For example, the system can re-execute semantic searches to further refine the relevant data returned. The refinement of the returned data can change not only the returned results, but also the relationships between the data in the returned results. In some embodiments, the user interface can be configured to adapt dynamically to the changes in the results and the changes in relationships between the data within the results. By dynamically adapting to contextual changes and changes in the relationship between data results, the user interface provides displays that emphasize contextually relevant results and learn from user needs and behavior.

In some embodiments, the system uses location information and information on available computing devices to transition the dynamic user interface displays between computing devices proximate to the user. For example, the user may view information on upcoming events and meetings on a laptop, tablet, or mobile phone while getting ready to go to work. As the user enters their vehicle, the system can detect the change in context (e.g., new location, new available computing devices, etc.) and transition the delivery of the dynamic user interface to a computing device in the vehicle. Further, the system can adapt the dynamic user interface according to the new context and situational needs of the user presented by entering the vehicle. In one example, the user interface can adapt to the user's need to travel by providing traffic information. In another example, the user interface can provide traffic and/or travel selections tailored to the user's schedule (e.g., directions to a first meeting) or expected travel (e.g., directions for a predicted destination from prior behavior). Adaptation of the user interface display can also include presentation of music selections relevant to the user as part of the dynamic user interface display. For example, the system can adapt the dynamic interface display responsive to the vehicle beginning travel to present music and/or radio options. In other settings, dynamic displays can be delivered to public devices. For example, the system can identify displays at a merchant or in a shopping context that are proximate to the user. In some examples, contextually relevant suggestions (e.g., based on prior purchase information) can be tailored into dynamic displays delivered to the user via the public displays.

In further aspects, the system can specifically tailor the dynamic user interface according to biomimicry algorithms. According to some embodiments, biomimicry algorithms are executed by the system to organize relevant data returned from semantic searching. The system can be configured to execute biomimicry algorithms to define subsets of relevant data to present in the user interface. In further embodiments, the system can generate the user interface and objects displayed according to clustering defined by the biomimicry algorithms. Accordingly, the system can organize the presentation within the user interface such that the display positions, size, movement, and/or emphasis within the dynamic user interface are controlled by execution of the biomimicry algorithms.

As disclosed herein various aspects of the present disclosure describe dynamically generating user interface displays comprising receiving contextual information related to at least one user, determining contextually relevant information based on information received or derived from information received, generating user interface objects organizing the contextually relevant information, and communicating the user interface objects to an at least one device. According to one embodiment, the method further comprises authenticating the at least one user. According to another embodiment, the method further comprises dynamically selecting the device based on the contextually relevant information, such as by location of one or more of the users or by position or other contextually relevant information. It is further contemplated to organize the contextually relevant information into clusters based on relationships within the contextually relevant information. In addition, the method as disclosed herein can include evaluating relationships within the contextually relevant information over time and modifying the generated clusters responsive to changing relationships

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a diagram of a system for delivering a dynamic user interface to associated user devices;

FIG. 2 is an example process flow for a method of generating a dynamic user interface, according to one embodiment;

FIGS. 3A-H are example user interface displays, according to one embodiment;

FIG. 4 is a block diagram of a general-purpose computer system on which various 25 aspects of the disclosure can be practiced; and

FIG. 5 depicts an example ecosystem according to various embodiments, and forms an instant part of the present disclosure; and

FIG. 6-11 show example user experiences according to various aspects of the disclosure and form an instant part of the present disclosure.

### DETAILED DESCRIPTION

There is a need for systems and methods for dynamic user interface delivery that is adaptable to the user's context and permits user data to flow to any device the user may encounter during daily activity.

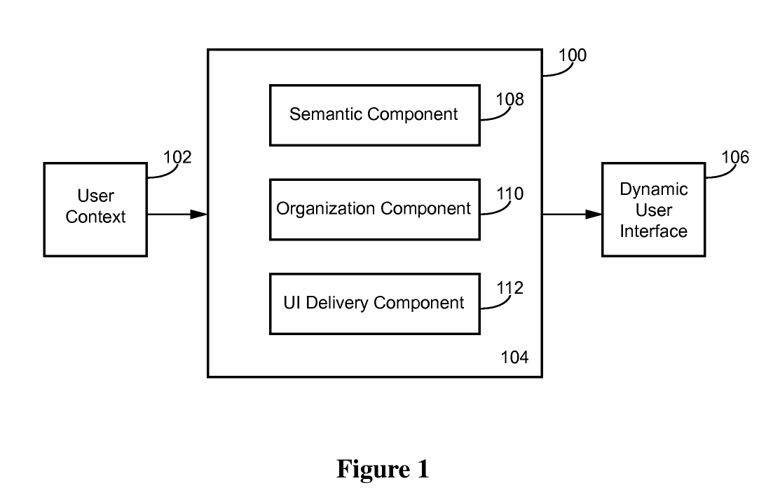

Shown in FIG. 1 is an example system architecture for a dynamic user interface (“UI”) system. The UI system 100 can be configured to receive user context 102 from user devices and process that context information to predict, adapt, organize and visualize contextually relevant information into a dynamic user interface display 106 delivered, for example, to the user's devices. In other examples, dynamic interface displays (e.g., 106) can be generated and delivered to other devices determined to be in proximity to the user. For example, the system 100 can deliver dynamic UI displays to computing systems in public spaces (e.g., merchant computer screens, library systems, public computer displays, billboards, etc.) and tailor the user interface shown according to contextual information for the user.

In some embodiments, the system is configured to use and/or provide contextual information based on the type of device to which the dynamic interface display is being delivered. For example, a user can specify what types of information can be accessed when delivering information to their own devices (e.g., unrestricted data access) as opposed to other display devices (e.g., merchant display screens) where the user can limit the data being used and/or delivered. In one example, the system 100 can capture identifying information for the user from a user device. The identifying information can include location information for the user, which can be delivered as user context 102. Once the user is identified, the system can access all available information on the user (e.g., preferences, prior behavior, time based activity, purchasing data, music preferences, shopping information, any computer interactions, etc.) stored, for example, in a user database 114.

The system can determine any information access restrictions based on the device to which the system will deliver content. For example, the system can be configured to identify public display devices, including for example, a merchant display system in proximity to the user's current location. Data limitations specified on the system (e.g., by the user), can limit data access to the user's location and prior purchase information at the particular merchant. Contextually relevant information can then be delivered to the merchant's display system related to prior purchases by the user. In another example, past purchases can result in the system generating suggestions for updated purchase options. In a supermarket setting, the system can even determine based on past purchase information that the user may have forgotten specific grocery items.

In some embodiments, the system can include a UI engine 104 configured to accept user context information 102 and generate dynamic user interfaces (e.g., 106) to deliver to computing systems, for example, determined to be in proximity to the user. The UI engine can include a plurality of processing components configured to perform various functions and/or operations disclosed herein. In one embodiment, the UI engine 104 includes a semantic component 108 configured to execute semantic searches against a database of user information. The semantic component 108 can return results from the database to an organization component 110 configured to cluster results into conceptually and/or contextually related clusters. In some examples, the organization component 110 can be configured to cluster results based on relationships within the data and/or distance determinations between the results. In one example, the organization component 110 is configured to execute biomimicry algorithms to cluster results from the user database 114. The clusters of information can be used by the UI delivery component 112 to generate dynamic user interface displays 106. The displays can then be communicated to identified devices and displayed to the user.

In some embodiments, a registration process can be executed to enable a user to specify devices on which they wish to receive information and/or dynamic displays. As part of registration, the user can be provided a portable key configured to handle identification and authorization of the user. In some embodiments, the portable key is a wearable device that provides for security, authentication, such as from fingerprints, biometrics, voice recognition, facial recognition, passwords, or other authentication methods known in the art; contextual information; and/or location information, such as, for example, based on location-based subsystems like GPS, cell tower triangulation, Wi-Fi sensors, accelerometers, or other location determination systems known in the art. In some examples, the wearable device can include a wristband, watch, key, tag, fob and/or other small form factor computing device. In other embodiments, the portable key can be implemented as part of a mobile device (e.g., smart phone, mobile phone, laptop, tablet, etc.) and the mobile device can provide for identification and authorization of the user within a UI system (e.g., 100).

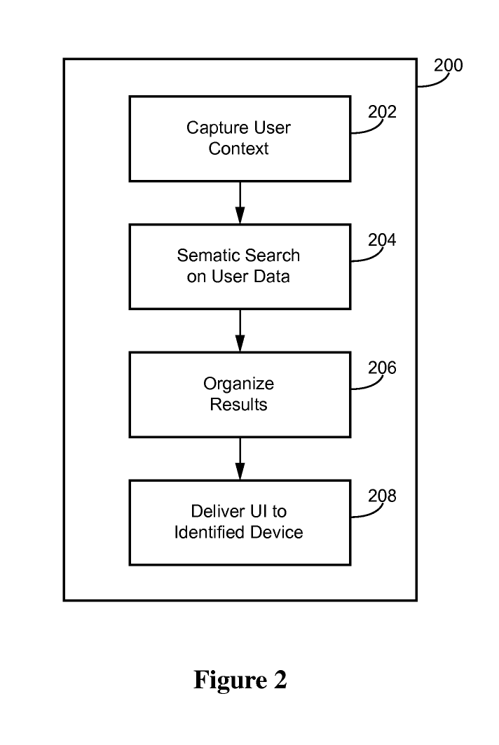

According to one embodiment, system 100 and/or UI engine 104 can execute a variety of processes to perform the functions and/or operations discussed herein. FIG. 2 shows a process 200 for generating a dynamic user interface. Process 200 begins at 202, with capture of user context information. As discussed above, a portable key can be associated with a specific user. The portable key can communicate context information, including for example, location information associated with the user. Context information can also include information on devices proximate to the user.

In some embodiments, the system maintains information on positioning of user devices in a user database as searchable context information, and determines what devices are proximate to the user based on the user's location information. In other embodiments, the portable key can provide information on proximate devices based on an ability to communicate with the proximate devices. Collection and processing of context information can use the portable key as one source of information. Any information captured by the portable key can be provided (e.g., time, user location, user position) to the system and each system interaction regarding a user activity (e.g. watching television, accessing FACEBOOK, driving to work) can be associated with the captured information. Thus, the database of user information provides contextually indexed information on user activity and user preferences.

Each user device connected to the system can also be used to capture or augment such contextual information. The contextual information can then be associated with user specific activities and/or preferences. Each user activity then becomes searchable based not only on what the user is doing, but also how the user is performing an activity, when the user is performing the activity, and/or why the user is performing the activity. Each aspect of the context allows the system to refine contextually options for presentation in the dynamic display.

In one example, a user returns from work and accesses FACEBOOK at the same time every work-day. The dynamic user interface system can be configured to activate the user's laptop (e.g., the user's preferred device) and automatically provide for the first selection in the user interface display to be an option for accessing FACEBOOK.

Collection and processing of context information and its association with user activity can also employ any accessible device proximate to the user, including public computing devices. In one example, public computer systems can provide video information on the user's current environment. The video information can then be stored and later search as contextual information on a particular activity. In some embodiments, the database of user information is configured to store all available context information in conjunction with user activity, user preferences, etc. In some implementations, external sources can be referenced to augment context. For example, posts on social media sites can be captured and used to augment contextual information in the user database. In some embodiments, the system can be configured to match existing contextual information and user activity with information from external sources, merging the information into a more complete description of the user. Context information can include current time, current location, user position (e.g., sitting, standing, etc.), and all available context information can be used to determine relevant information for the user's current context. In some embodiments, user devices can provide context information in the form of captured audio and/or video. The audio and video information can be used to provide information on context, including environment information. The environmental context can then be used to by the system to identify relevant data for the current user's context. For example, relevant information can be obtained at 204 based on execution of semantic searching on information available for the user. In some examples, information is captured and stored on the user through the context information delivered by the portable key. The data on the user can be accumulated through multiple interactions with the UI system. Each interaction provides additional context information on the user, the user's preference, activities, timing of activity, location of activity among other options. In other examples, information on the user can be captured from external systems.

According to one embodiment, social media platforms provide an abundance of contextual information on user (e.g., detailing activities and timing, location, preferences, etc.). Example social media systems that can be accessed include FACEBOOK, TWITTER, SPOTIFY, PANDORA, YELP, etc. Any social media system accessed by the user can be used by the system to capture context information on the user. In other embodiments, any third party service can also be accessed to provide information on user activity to capture and store contextual information (e.g., e-mail accounts, work sharing sites, blog posts, productivity sites, retail sites (e.g., detailing purchases, product preference, etc.), credit cards sites, etc.).

Process 200 continues at 206 with organization of the results returned from the semantic search on the user data. Organization at 206 can include clustering of returned results based on any one or more of concepts, relevancy to current context, relevancy to a predicted context, the device on which the display will be rendered, information limitations, distance calculations, etc. Once organized, visualization of the relevant information can be communicated to a device proximate to the user at 208 for display. Specific devices can be identified at 208 to receive the visualization for display. In some embodiments, devices can be identified based on proximity to the user, and matched against the user's current needs. Where multiple devices are returned the system can use contextual information to determine which device the user is likely to require and deliver the dynamic interface accordingly.

### EXAMPLE IMPLEMENTATIONS

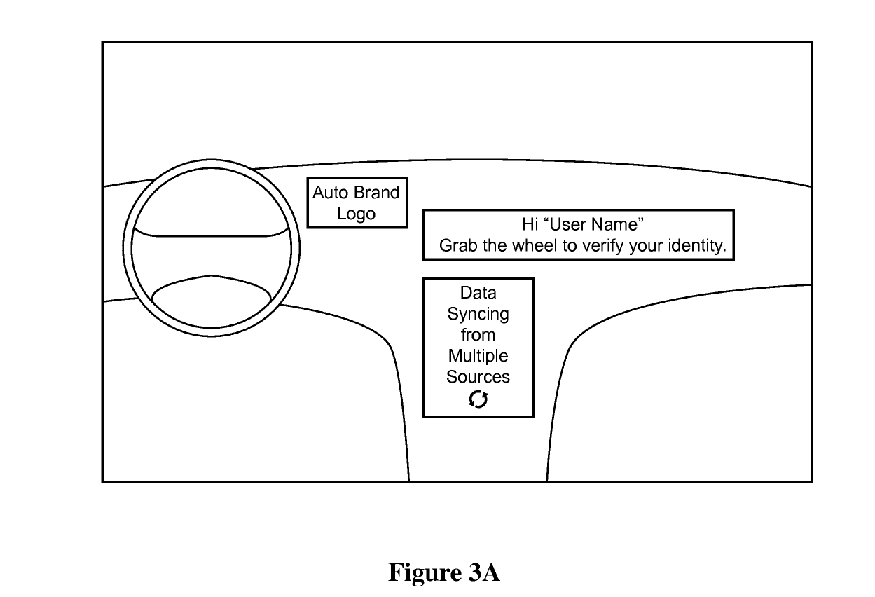

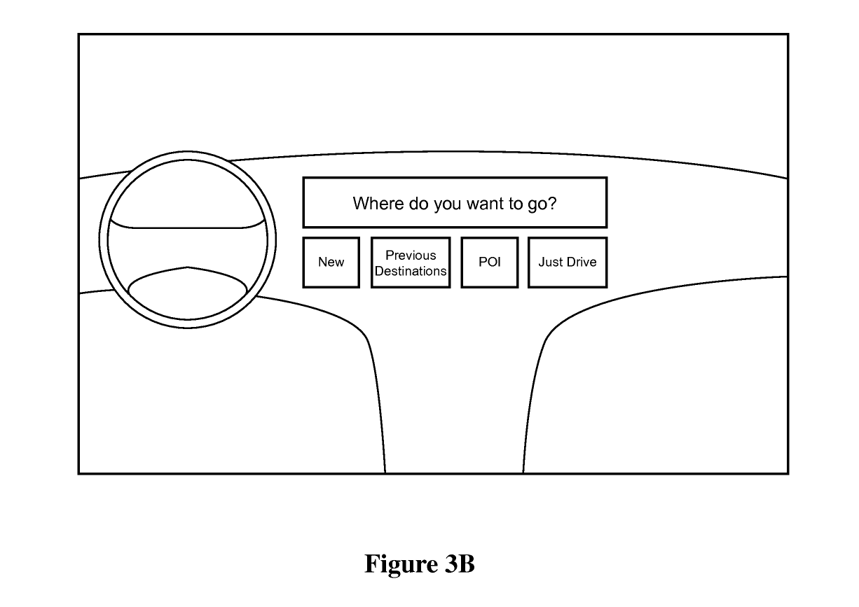

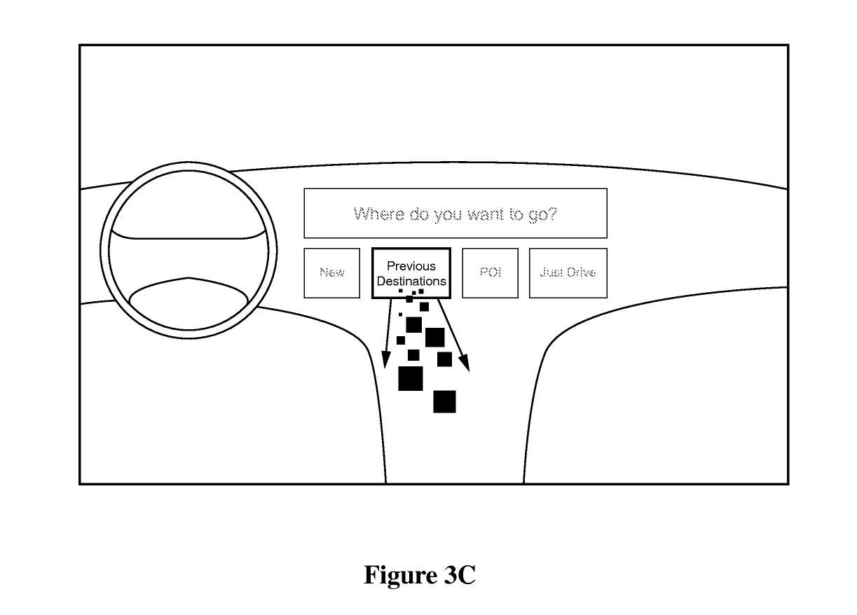

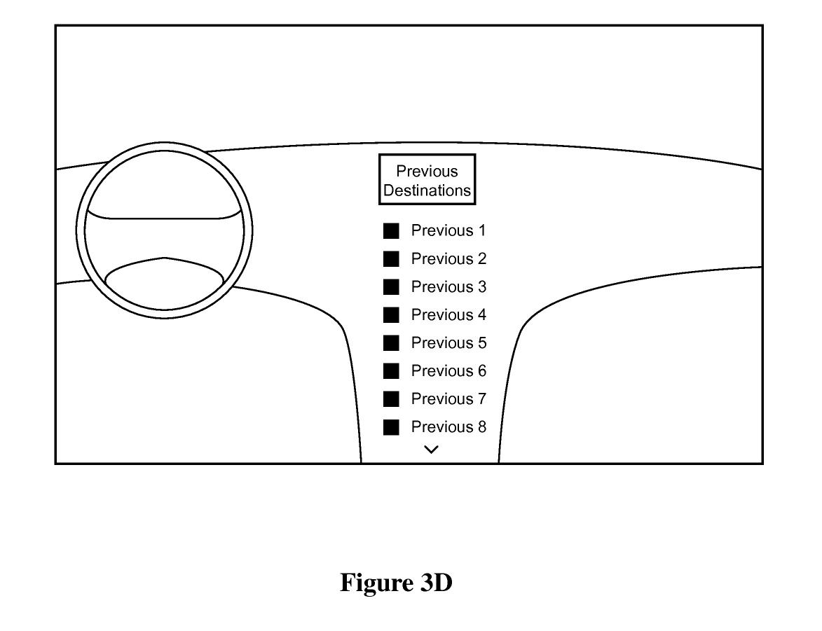

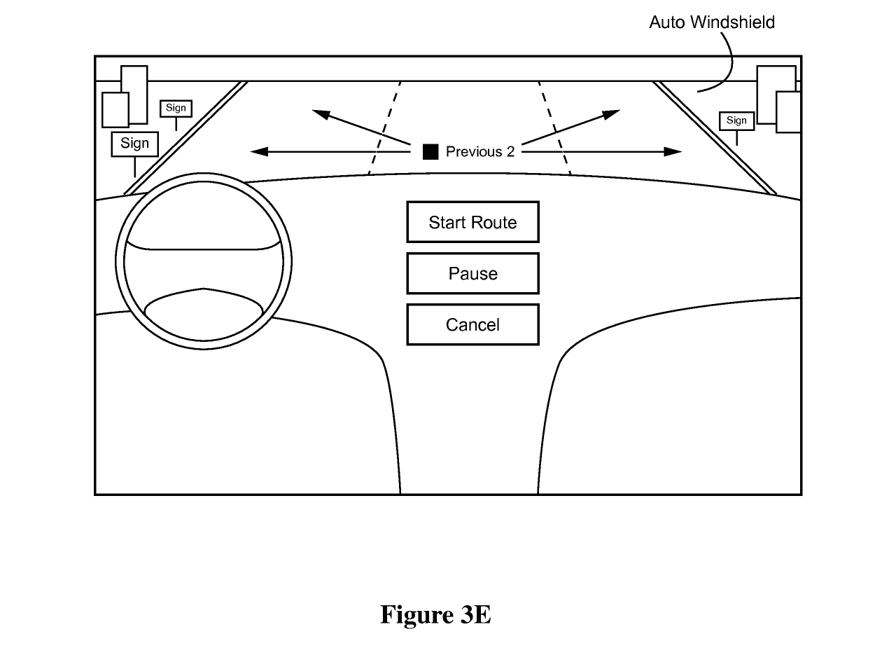

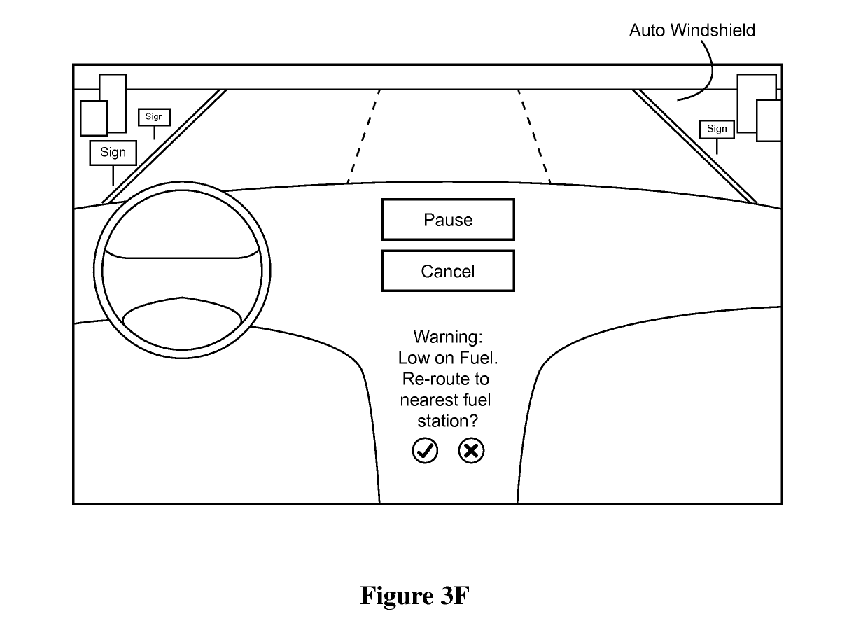

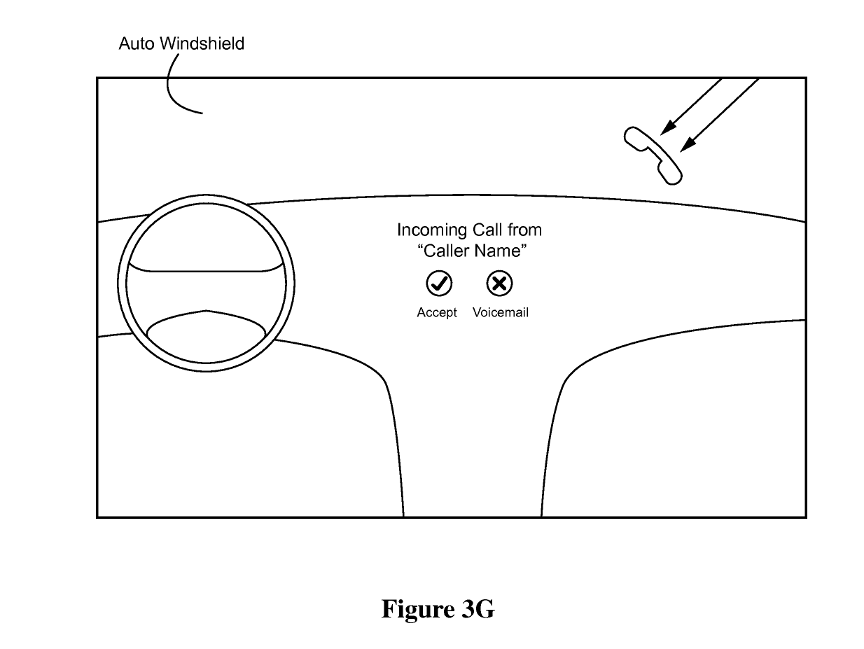

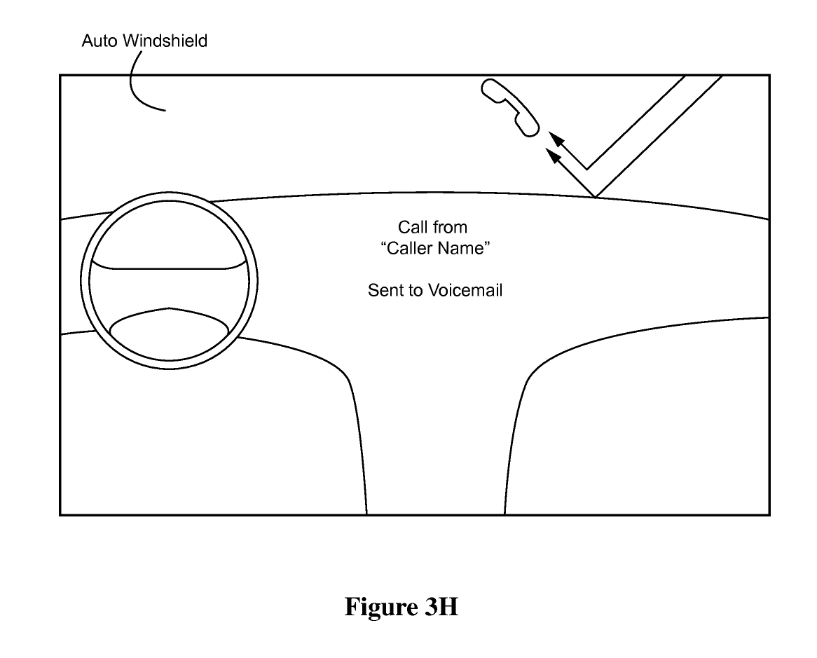

Illustrated in FIGS. 3A-3H are example user interfaces generated and displayed on a vehicle heads up display according to one embodiment. FIG. 3A illustrates a user interface that provides a confirmation of the user's identity as determined by the system. According to some embodiments, the system determines the user's context and need from location information provided by a portable key. For example, based on a user need for directions to travel, the system can be configured to provide a display as shown in FIG. 3B. Previous destinations can be captured and organized by the system according to contextual relevancy, and displayed as shown in FIGS. 3C and 3D. FIG. 3E shows displays for routing information during travel. FIG. 3F illustrates a user interface for delivering a notification to the user of events that require a response. In this example, the system determines that the vehicle is low on fuel and provides options to re-route to the nearest gas station.

According to some embodiments, the system is configured to determine if specific events require interruption of a current activity. Shown in FIG. 3G is a user interface for displaying alert notifications. In this example, an incoming call has been detected by the system. Based on, for example, prior behavior, the system determines that the user accepts calls from the current source (e.g., “Caller Name”). In some embodiments, the system can be configured to fade the driving directions into the background as the user accepts the call from Caller. Shown in FIG. 3H is a user interface display for not accepting an incoming call. In one example, an unrecognized number can be automatically diverted by the system to voicemail. In another example, the user's prior behavior can be analyzed to determine if the user would take the call, and the system can act appropriately based on the determination. For example, as indicated in FIG. 3H, the call can be automatically routed to voicemail.

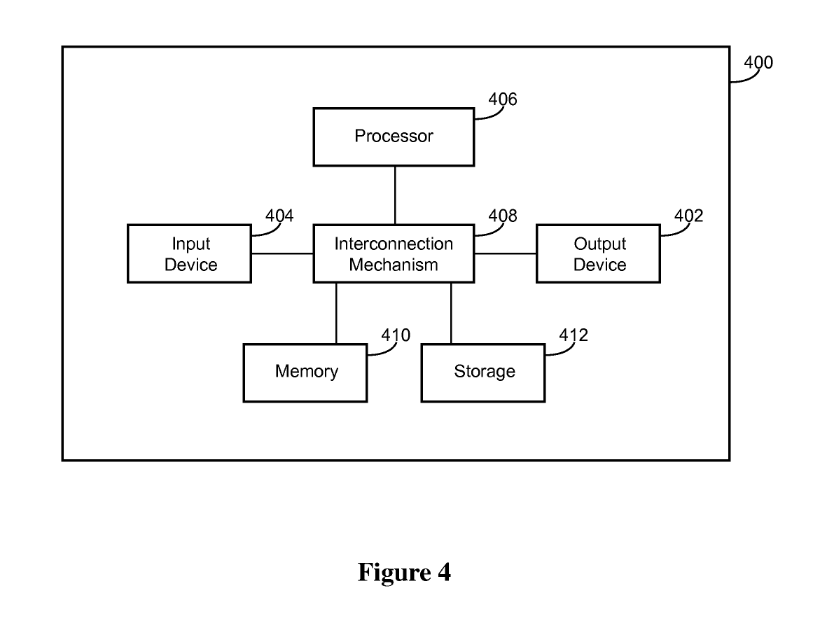

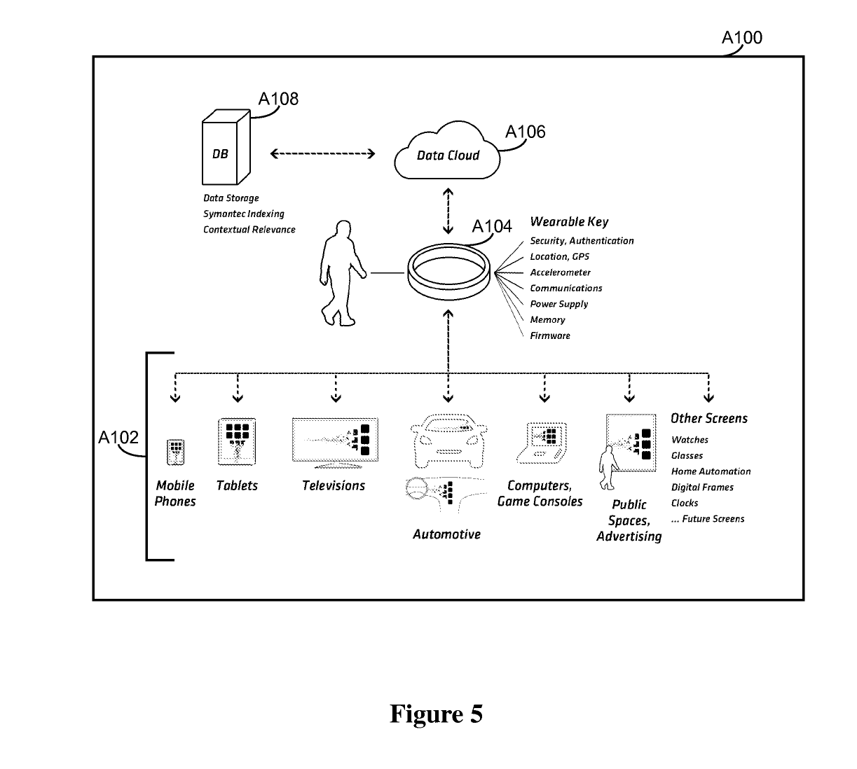

Illustrated in FIGS. 4-11 are further examples of system elements and use scenarios associated with various embodiments of systems and methods for dynamic user interface generation and delivery. Shown in FIG. 5 are example elements (e.g., examples of computing devices A102, wearable key A104, data cloud A106, and database A108) in a system for generating and delivering dynamic user interface displays. According to some embodiments, the system A100 for dynamic user interface generation and display integrates data on users from multiple sources. Data can be captured from the user's own devices (e.g., any computer activity can be captured and stored; the data can be stored in conjunction with context information (e.g., location, time, etc.). System A100 can use data cloud A106 to store information on the user. The data cloud can be coupled to one or more database storage systems (e.g., A108). Data can also be captured from external sources (e.g., social media sites, location based services, third party subscriber services, applications on the user's devices, e-mail accounts, etc.). In some embodiments, the database storage systems (e.g., A108) are configured to index the data on the user based on natural language concept indexing. Natural language indexing can improve the system analysis of user intent, and facilitate contextual meaning discovery, for example, based on location, time, prior habit, and current situational needs. Further embodiments can be configured to index on concepts alone, and can also index on combinations of concepts, timing, location, and situational need.

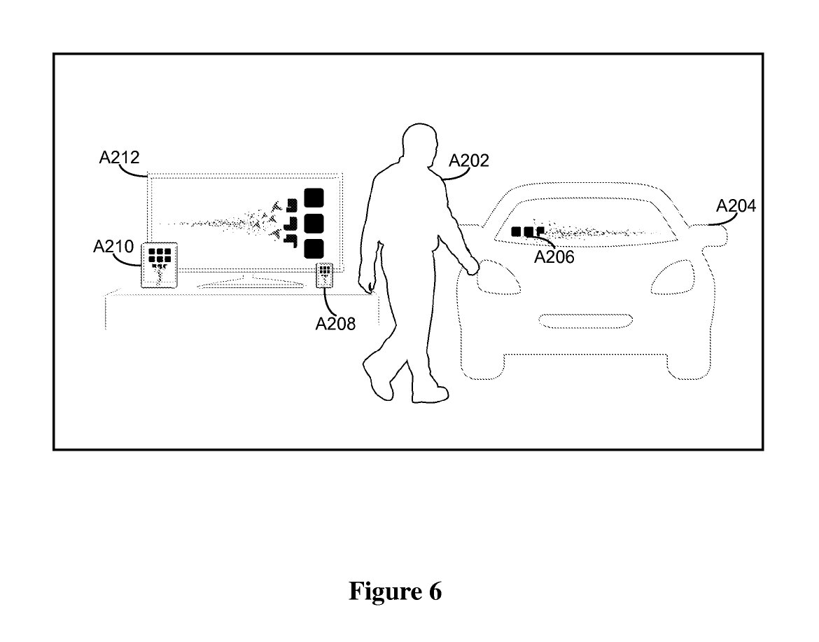

Shown in FIG. 6, a user's (e.g., A202) position can be used in relation to devices associated with the user to deliver contextually relevant and dynamic user interfaces. For example, as the user nears their vehicle A204, the system can generate user interface displays relevant to the user's current context associated with the vehicle, which can be further refined based on the timing of the need (e.g., prior history can establish the user commutes to work at this time). Additionally, the system can select a particular device or display based on the user's location and proximity to other devices. In this example, a heads up display (“HUD”) integrated in the vehicle A206 can be the identified display, and dynamic user interfaces generated and delivered to the HUD. Other devices can be detected (e.g., mobile phone A208, tablet A210 and TV A212) but based on current situational need determined by the system, the system can select the HUD A206 to receive the dynamic user interface display.

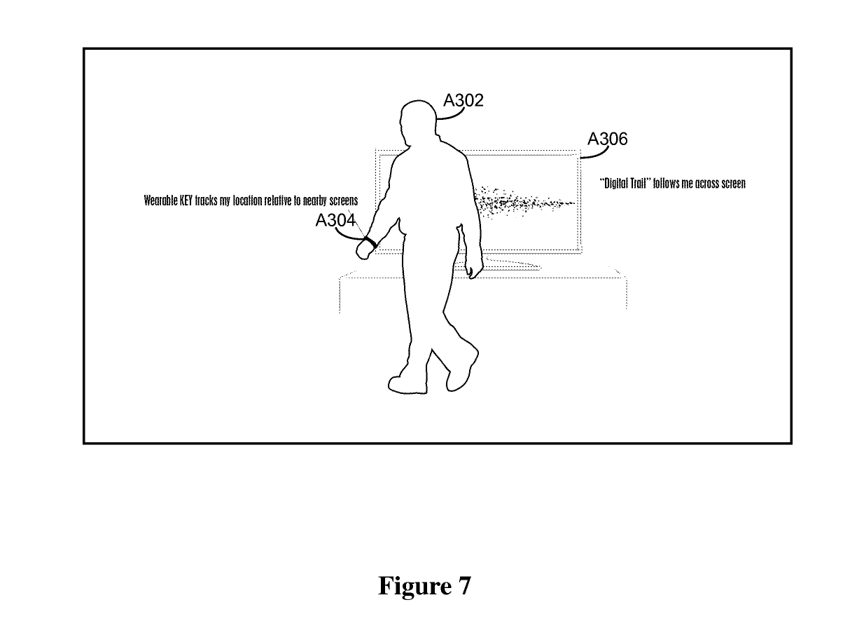

Shown in FIG. 7, the user A302 position can be determined from information provided to the system by portable key A304 (e.g., electronic wristband, watch, ring, mobile device, tag). Based on proximity to the user's televisions A306, dynamic user interface displays can be generated and delivered to the television A306. In some embodiments, the system can determine user situational need based on changing location information. For example, walking past television A306 may trigger delivery of dynamic user interface displays. Alternatively, user displays can be configured to provide short notification messages to a user walking past the television A306.

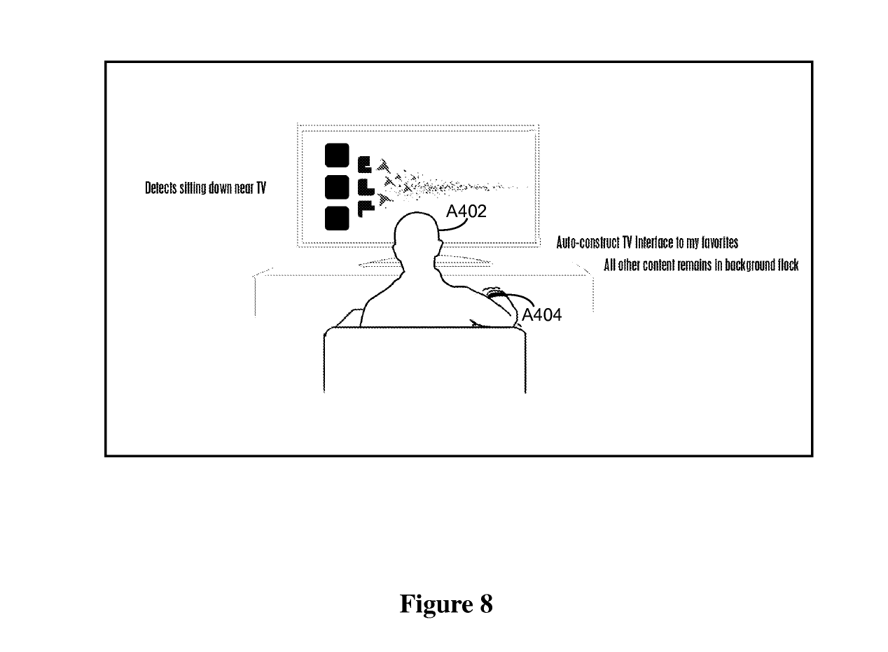

In another example, shown in FIG. 8, changing of user A402 position such as by sitting down near a T.V. can be detected by the system. In some embodiments, the portable key A404 can include an accelerometer configured to provide information on changes in user position. The user's position can be provided as part of the user's context. As discussed above, any information on user context can be incorporated, for example, in semantic searches against user data. The results returned from the semantic searching can be organized based on relationships within the data and/or to the user's current context. In some examples, the relationship between data can be defined on contextual information (e.g., location, timing, user activity, environmental context, etc.).

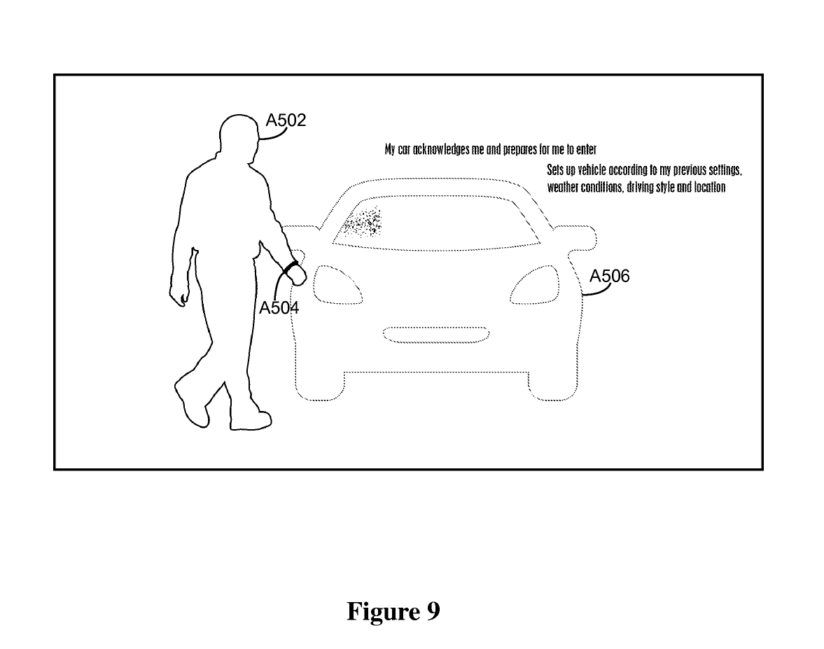

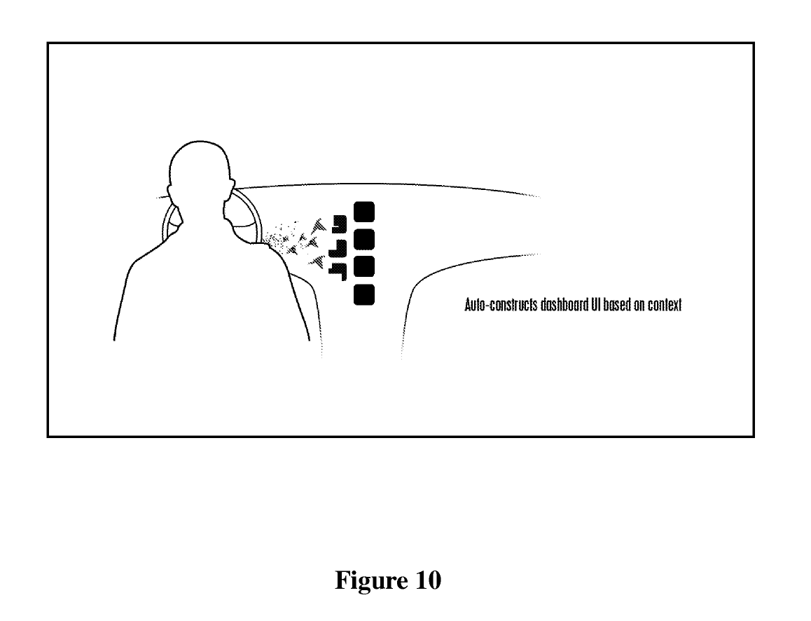

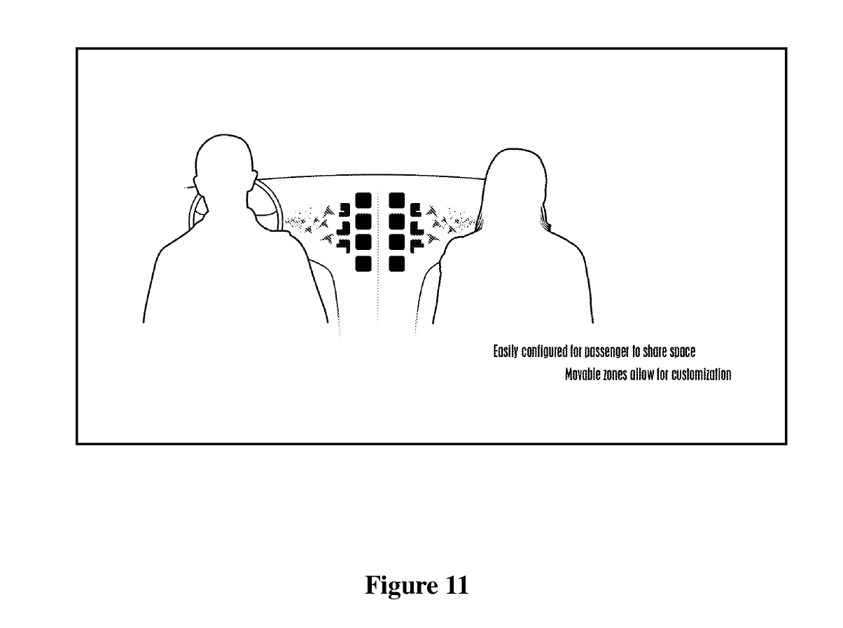

According to some embodiments, the system automatically constructs a dynamic user interface, which may include for example, viewing favorites of the user. The viewing favorites can be organized based on current time, past behavior, etc. For example, biomimicry algorithms can be executed to generate positioning and further organization of user interface elements displayed on the television. In one example, contextually matched favorites appear in larger size, or with some visual emphasis, while other content remains in the background or visually de-emphasized. 100301 Returning to the car example (FIG. 9), the system can detect a user A502 approaching vehicle A506, based on location information communicated by portable key A504. Based on contextual information, the system can also configure the vehicle according to user preferences and current context (e.g., seat position, headlights on/off, driving style, location, music preferences, contacts, and prior destinations). In some embodiments, the system can determine additional context information for the user based on external references. For example, the system can determine driving conditions based on weather reports, time of day, and traffic information. The system can provide for the car headlights to be on responsive to time and/or user preference. Further, the system can activate windshield wipers based on weather conditions. In further embodiments, the wearable key can also be used to gather other contextual information, e.g., video, audio, motion, humidity, light, eternal temperature as well as the body temperature of user A502, and proximity to other sensors or devices. The video, audio, and temperature information can be used by the system to determine contextually relevant data and/or configuration to provide to the user. Additionally, the contextual information can be stored for subsequent activity, and the current behavior of the user matched with the additional. contextual information. According to some embodiments, the system automatically constructs a user interface based on contextually relevant information for display in the vehicle (see FIG. 10). According to other embodiments, the system can also provide for user interface displays that accommodate multiple users shown in FIG. 11. A second user may also be registered with the system and contextual results and dynamic user interface display can be generated based on information for the second identified user. According to some embodiments, the system can recognize and generate displays for any number of users. In others, the presence of the second person can be stored as part of the identified user's information and preferences of the second person captured as part of the identified user's data.

Various embodiments according to the present disclosure may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor. It should be appreciated that one or more of any type of computer system may be used to facilitate dynamic user interface generation and delivery system according to various embodiments. Further, the system may be located on a single computer or may be distributed among a plurality of computers attached by a communications network.

A general-purpose computer system according to one embodiment is configured to perform any of the described functions, including but not limited to capturing contextual information, indexing contextual information based on any one or more or concepts, natural language, and relevancy, determining current context, determining situational needs, executing semantic searches, accepting user requests, focusing semantic searches responsive to user request, integrating data sources (e.g., data on user devices, data on social media sites, data on third party sites, data for location based services, etc.), defining context-based connections, defining search intent, determining contextual meaning of terms from searchable data spaces, etc. It should be appreciated, however, that the system may perform other functions, including but not limited to visualizing contextual data, identifying and recording contextual relationships, applying any one or more of location, time, user habit, and current need to determine context, generating special relationships between visualizations of objects, determining distance between data objects, maintaining relevancy-based distance information between data object, maintaining relevancy-based distance between nearest neighboring object, and updating spatial context dynamically as relevance distance changes. The disclosure is not limited to having any particular function or set of functions.

FIG. 4 shows a block diagram of a general-purpose computer system 400 in which 20 various aspects of the present disclosure may be practiced. For example, various aspects of the disclosure may be implemented as specialized software executing in one or more computer systems including general-purpose computer systems communicating over a communication network. Computer system 400 may include a processor 406 connected to one or more memory devices 410, such as a disk drive, memory, or other device for storing data. Memory 410 is 25 typically used for storing programs and data during operation of the computer system 400. Components of computer system 400 may be coupled by an interconnection mechanism 408, which may include one or more busses (e.g., between components that are integrated within a same machine) and/or a network (e.g., between components that reside on separate discrete machines). The interconnection mechanism enables communications (e.g., data, instructions) to be exchanged between system components of system 400.

Computer system 400 may also include one or more input/output (I/O) devices 402-404, for example, a keyboard, mouse, trackball, microphone, touch screen, printing device, display screen, speaker, etc. Storage 412 typically includes a computer readable and writeable nonvolatile recording medium in which signals are stored that define a program to be executed by the processor or information stored on or in the medium to be processed by the program.

The medium may be, for example, a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM).

The memory may be located in storage 412 as shown, or in memory system 410. The processor 406 generally manipulates the data within the memory 410, and then copies the data to the medium associated with storage 412 after processing is completed. A variety of mechanisms are known for managing data movement between the medium and integrated circuit memory element and the disclosure is not limited thereto. The disclosure is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent system component, for example a UI engine, semantic component, organization component, UI delivery component, etc.

Although computer system 400 is shown by way of example as one type of computer system upon which various aspects of the invention may be practiced, it should be appreciated that aspects of the invention are not limited to being implemented on the computer system as shown in FIG. 4. Various aspects of the disclosure may be practiced on one or more computers having different architectures or components that are shown in FIG. 4.

Computer system 400 may be a general-purpose computer system that is programmable using a high-level computer programming language. Computer system 400 may be also implemented using specially programmed, special purpose hardware. In computer system 400, processor 406 is typically a commercially available processor such as the well-known Pentium class processor available from the Intel Corporation. Many other processors are available. Such a processor usually executes an operating system which may be, for example, the Windows-based operating systems (e.g., Windows Vista, Windows NT, Windows 2000 (Windows ME), Windows XP, Windows VISTA, and Windows 7 & 8 operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the disclosure is not limited to any particular operating system.

The processor and operating system together define a computer platform for which application programs in high-level programming languages are written. It should be understood that the disclosure is not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the disclosure can be practices on cloud based computer resources and/or may integrated elements of cloud compute systems. In another example, various aspects of the disclosure may be distributed among one or more computer systems (e.g., servers) configured to provide a service to one or more client computers, or to perform an overall task as part of a distributed system. In other examples, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP).

It should be appreciated that the disclosure is not limited to executing on any particular system or group of systems. Also, it should be appreciated that the disclosure is not limited to any particular distributed architecture, network, or communication protocol.

Various embodiments of the present disclosure may be programmed using an object-oriented programming language, such as Java, C++, Ada, or C# (C-Sharp). Other object-oriented programming languages may also be used. Alternatively, functional, scripting, and/or logical programming languages may be used. Various aspects of the disclosure may be implemented in a non-programmed environment (e.g., documents created in HTML, XML or other format that, when viewed in a window of a browser program, render aspects of a graphical-user interface (GUI) or perform other functions). Various aspects of the disclosure may be implemented as programmed or non-programmed elements, or any combination thereof.

Various aspects of this system can be implemented by one or more systems similar to system 400. For instance, the system may be a distributed system (e.g., client server, multi-tier system) comprising multiple general-purpose computer systems. In one example, the system includes software processes executing on a system associated with a user (e.g., a client computer system). These systems can be configured to accept user identification of social networking platforms, capture user preference information, accept user designation of third party services and access information subscribed to by the user, communicate context information, identify users, etc. There may be other computer systems, such as those installed at a user's location or accessible by a user (e.g., a smart phone) that perform functions such as displaying dynamic user interface displays, among other functions. As discussed, these systems may be distributed among a communication system such as the Internet.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A system for dynamically generating user interface displays across connected devices, the system comprising:
at least one device for displaying user interface displays;
at least one processor operatively connected to a memory, the processor when executing is configured to:
receive contextual information related to at least one user;
determine contextually relevant information based on information received or derived from the information received;
generate user interface objects organizing the contextually relevant information; and communicate the user interface objects to the at least one device.

2. The system according to claim 1, further comprising a portable key configured to authenticate the user.

3. The system according to claim 2, wherein the portable key includes location based subsystems.

4. The system according to claim 3, wherein the portable key includes network communication subsystems.

5. The system according to claim I, wherein the at least one processor when executing is configured to access a database of contextual information.

6. The system according to claim 5, wherein the at least one processor when executing is configured to generate a semantic index of content within the database of contextual information.

7. The system according to claim 5, wherein the at least one processor when executing is configured to generate a natural language index of content within the database of contextual information.

8. The system according to claim 1, wherein the at least one processor when executing is configured to capture contextual information for the at least one user from the group consisting of the at least one device, social media sources, and location-based services.

9. The system according to claim 5, further comprising at least two devices for displaying user interface displays, wherein the processor is configured to select, based on the contextual information, at least one of the devices.

10. The system according to claim 1, wherein the at least one processor when executing is configured to execute a semantic search responsive to the context information to determine the contextually relevant information.

11. The system according to claim 10, wherein the at least one processor when executing is configured to organize the contextually relevant information into clusters.

12. The system according to claim 11, wherein the at least one processor when executing is configured to generate the clusters of the contextually relevant information based on relationships within the contextually relevant information.

13. The system according to claim 11, wherein the at least one processor when executing is configured to generate the clusters of the contextually relevant information based on biomimicry algorithms.

14. The system according to claim 12, wherein the at least one processor when executing is configured to
evaluate relationships within the contextually relevant information over time; and
modify the generated clusters responsive to changing relationships (e.g., responsive to new context information).

15. A method for dynamically generating user interface displays comprising:
receiving contextual information related to at least one user;
determining contextually relevant information based on information received or derived from information received;
generating user interface objects organizing the contextually relevant information; and
communicating the user interface objects to an at least one device.

16. The method of claim 15 further comprising authenticating the at least one user.

17. The method of claim 16 further comprising dynamically selecting the device based on the contextually relevant information.

18. The method of claim 15 further comprising organizing the contextually relevant information into clusters based on relationships within the contextually relevant information.

19. The method of claim 18 further comprising:
evaluating relationships within the contextually relevant information over time; and modifying the generated clusters responsive to changing relationship.

20. The method of claim 17, wherein the selection is made based on the location of the at least one user.
